(19) United States
(12) Patent Application Publication
(10) Pub. No.: US 2019/0287697 A1
(43) Pub. Date: Sep. 19, 2019

(54) METAL WIRE ARMORED OPTOELECTRONIC HYBRID CABLE

(71) Applicant: ROSENBERGER(SHANGHAI)TECHNOLOGY CO., LTD, Shanghai (CN)

(72) Inventors: Chaohui ZHANG, Shanghai (CN); Tuanjie CHEN, Shanghai (CN)

(73) Assignee: Rosenberger(Shanghai)Technology Co., Ltd, Shanghai (CN)

(21) Appl. No.: 16/318,309

(22) PCT Filed: Jan. 30, 2018
(86) PCT No.: PCT/CN2018/074559

§ 371 Date: Jan. 16, 2019

(30) Foreign Application Priority Data
Mar. 8, 2017 (CN) 201710133559.5

(51) Int. Cl. H01B 7/04; H01B 11/22; H01B 7/22; H01B 7/282; H01B 7/18

(52) U.S. Cl. CPC H01B 7/04; H01B 11/22; H01B 7/182; H01B 7/282; H01B 7/22

(57) ABSTRACT

The present invention discloses a metal wire armored optoelectronic hybrid cable, which comprises an optoelectronic hybrid unit, a metal wire armoring and an outer protection casing. The optoelectronic hybrid unit comprises an electrical unit and an optical unit which are mixed. The metal wire armoring wraps the optoelectronic hybrid unit. The outer protection casing wraps the metal wire armoring. In the present invention, due to the use of the metal wire armoring, the bending performance is favorable, the production and processing processes are simple, and the production cost of the hybrid cable is greatly reduced.

### RELATED APPLICATION

The present application claims priority under 35 U.S.C. § 119 to Chinese Patent Application 201710133559.5, filed on Mar. 8, 2017, which is incorporated by reference herein in its entirety.

### TECHNICAL FIELD

The present invention relates to an optoelectronic hybrid cable, in particular, to a metal wire armored optoelectronic hybrid cable.

### BACKGROUND

In the field of optical fiber core communication, an optoelectronic hybrid corrugated cable has begun to be widely used in this industry. The optoelectronic hybrid corrugated cable mainly integrates an optical unit and an electrical unit into one cable so as to meet the requirements of optical communication and electrical communication.

As shown in FIG. 1 and FIG. 2, FIG. 1 is a perspective view of an optoelectronic hybrid corrugated cable in the prior art. FIG. 2 is a sectional view of FIG. 1, and comprises an optical and electrical hybrid unit 10, a corrugated cable 20 and an outer protection casing 30, wherein the optical and electrical hybrid unit comprises an electrical unit and an optical unit; the corrugated cable 2 wraps the optical and electrical hybrid unit 10; the outer protection casing 30 wraps the corrugated cable 20. Specifically, the electrical unit comprises one or more telecommunication links, and each telecommunication link comprises a power conductor 11 formed by stranding a plurality of metal wires and an insulating material 12 wrapping the power conductor 11. The optical unit comprises an optical fiber 13 and an optical fiber cladding layer wrapping the optical fiber 13, and the optical fiber cladding layer comprises an aramid material layer 14 wrapping the optical fiber 13 and a middle layer 15 wrapping the aramid material layer 14. One or more pairs of optical fibers 13 may be arranged.

However, the above-mentioned optoelectronic hybrid corrugated cable has a poor bending performance due to the use of a metal corrugated armoring, and the processing technology for producing the metal corrugated armoring is relatively complicated, the processing time is long, and the cost is high. In addition, the above-mentioned existing optoelectronic hybrid corrugated cable also has other problems, such as poor water blocking performance of the cable and difficulty in stripping the cable when it is used.

### SUMMARY

An objective of the present invention is to overcome the defects of the prior art and provides a metal wire armored optoelectronic hybrid cable which exhibits a good bending performance and reduces the production cost.

In order to achieve said objective, the present invention proposes the following technical solution: a metal wire armored optoelectronic hybrid cable comprises an optoelectronic hybrid unit, a metal wire armoring and an outer protection casing, wherein the optoelectronic hybrid unit comprises an electrical unit and an optical unit which are mixed; the metal wire armoring wraps the optoelectronic hybrid unit; the outer protection casing wraps the metal wire armoring.

Preferably, the metal wire armoring is formed by wrapping the optoelectronic hybrid unit with at least a metal line in an axial or radial direction of the optoelectronic hybrid unit.

Preferably, the metal line is a single metal wire or is formed by doubling and stranding a plurality of metal wires together.

Preferably, the optoelectronic hybrid unit further comprises at least one reinforcement that is mixed with the optical unit and the electrical unit.

Preferably, the metal wire armoring further a water-blocking tape between the optoelectronic hybrid unit and the metal wire armoring.

Preferably, the water-blocking tape wraps the optoelectronic hybrid unit, and the metal wire armoring wraps the water-blocking tape.

Preferably, the water-blocking tape comprises a first water-blocking tape and a second water-blocking tape, wherein the first water-blocking tape wraps the optoelectronic hybrid unit, and the second water-blocking tape is located outside the first water-blocking tape.

Preferably, the metal wire armoring further comprises an inner protection casing which wraps the first water-blocking tape, and the second water-blocking tape wraps the inner protection casing.

Preferably, the metal wire armoring further comprises a rip cord which is arranged on the metal wire armoring, or simultaneously arranged on the metal wire armoring and the first water-blocking tape.

Preferably, the metal wire armoring is made of aluminum, magnesium or copper.

Preferably, the electrical unit comprises at least two telecommunication links, and each telecommunication link comprises a power conductor formed by stranding a plurality of metal wires and an insulating material wrapping the power conductor.

Preferably, the optical unit comprises one or more pairs of optical fiber cores.

Preferably, the inner protection casing and the outer protection casing are made of a flame-retardant, ultraviolet-resistant insulating material, and the insulating material is selected from PVC (Polyvinyl chloride), PE (polyethylene) or LSZH (Low Smoke Zero Halogen).

Compared with the prior art, the metal wire armored optoelectronic hybrid cable of the present invention has the following advantages:

1. the metal wire armoring which has a favorable bending performance is superior to the metal corrugated armoring of the existing structure; and the production and processing cost of a metal wire combed armoring is far lower than the production and processing cost of the corrugated armoring, and therefore the production cost of the hybrid cable is greatly reduced.

2. The water-blocking tape or the inner protection casing is used to enhance the water blocking performance of the cable; a rip cord is additionally arranged to reduce the stripping difficulty of the cable.

### BRIEF DESCRIPTION OF THE DRAWINGS

FIG. 1 is a perspective view of an optoelectronic hybrid corrugated cable in the prior art.

FIG. 2 is a sectional view of FIG. 1;

FIG. 3 is a sectional view of a metal wire armored optoelectronic hybrid cable;

FIG. 4 is a sectional view of another embodiment of a metal wire armored optoelectronic hybrid cable of the present invention; and

FIG. 5 is a perspective view of yet another embodiment of a metal wire armored optoelectronic hybrid cable of the present invention.

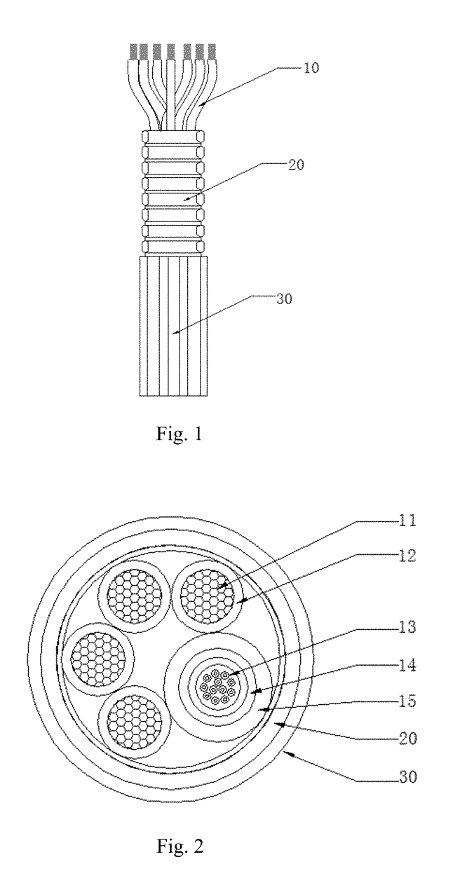

### DETAILED DESCRIPTION

The technical solutions of the embodiments of the present invention will be clearly and completely described below with reference to the accompanying drawings.

According to a metal wire armored optoelectronic hybrid cable disclosed by the present invention, a metal wire combed armoring is adopted, which mainly improve the bending performance and the processing and production process of the existing corrugated armored hybrid cable.

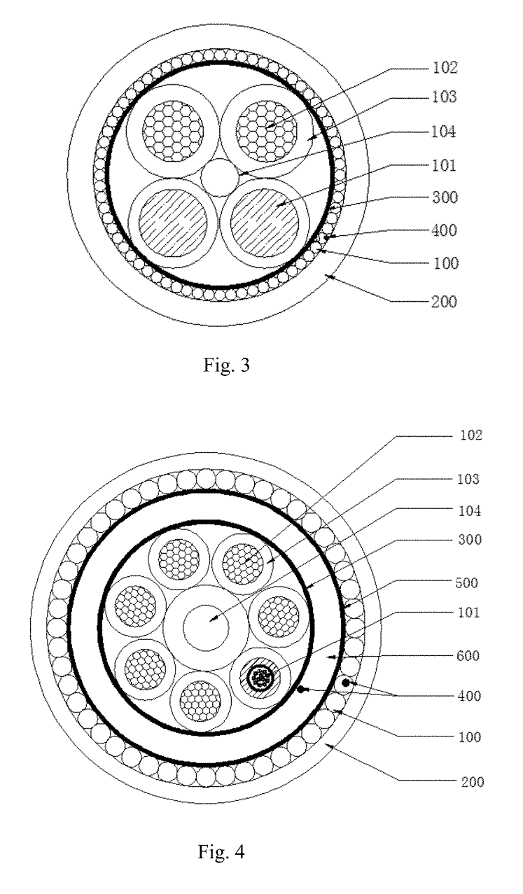

As shown in FIGS. 3 to 5, a metal wire armored optoelectronic hybrid cable disclosed by the present invention comprises an optoelectronic hybrid unit, a metal wire armoring 100 and an outer protection casing 200, wherein the metal wire armoring wraps the optoelectronic hybrid unit, and the outer protection casing 200 wraps the metal wire armoring 100.

Specifically, the optoelectronic hybrid unit comprises an electrical unit and an optical unit 101 which are mixed, wherein the electrical unit comprises at least two telecommunication links; each telecommunication link comprises a power conductor 102 formed by stranding a plurality of metal wires and an insulating material 103 wrapping the power conductor 102; the insulating material 103 has a circular or fan-shaped cross section. The optical unit 101 comprises one or more pairs of optical fiber cores.

Further, the specifications of the power conductor 102 can be selected according to customer requirements, and can be 12 AWG (4 mm²), 10 AWG (6 mm²), 8 AWG (10 mm²), etc. The insulating material 103 and the thickness satisfy the voltage requirement of 0.6/1 KV. The optical fiber core can be a single-mode optical fiber core or a multi-mode optical fiber core according to customer requirements, and the number of optical fiber cores may also be determined according to customer requirements.

Preferably, the optoelectronic hybrid unit further comprises at least one reinforcement 104 which is mixed with the optical unit 101 and the electrical unit. One or more reinforcements may be provided to increase the pulling force of the cable.

Further, a metal wire armored optoelectronic hybrid cable disclosed by the present invention further comprises a water-blocking tape 300. As shown in FIG. 3, the water-blocking tape 300 wraps the optoelectronic hybrid unit, and mainly functions to prevent water from entering the hybrid cable.

The metal wire armoring 100 wraps the water-blocking tape 300 and is mainly used to enhance the mechanical strength of the hybrid cable, thereby protecting the hybrid cable from being damaged by an external mechanical force, from being corroded by chemical gases, or the like. Specifically, the metal wire armoring 100 is formed by wrapping the water-blocking tape with at least a metal line in an axial or radial direction of the optoelectronic hybrid unit, and the metal line is a single metal wire or is formed by doubling and stranding a plurality of metal wires. Preferably, the metal wire may be an aluminum wire, a magnesium wire, a copper wire, or the like.

A wrapping process of the metal wire armoring lies in that: if the hybrid cable is relatively large and the number of metal wires (such as copper wires) is large, the metal wires are first grouped according to the required number, and then doubled and stranded into a plurality of metal wires; then, the stranded metal wires are installed to a cage type strander; if the number of the metal wires is not large, the metal wires are directly installed on the cage type stranded (that is, directly as a single metal wire), without a doubling process; the semi-finished product of the extruded hybrid cable is discharged through a center hole of the cage type strander, and meanwhile, a pay-off frame of the cage type strander begins to rotate; the doubled metal lines are uniformly bundled over the entire outer surface of the water-blocking tape.

The metal wire armoring which has a favorable bending performance is superior to the metal corrugated armoring of the existing structure; and the production and processing cost of a metal wire combed armoring is far lower than the production and processing cost, and therefore the production cost of the hybrid cable is greatly reduced.

Further, in terms of size setting, the outer diameter of the metal wire armoring is equal to the outer diameter of a coaxial feeder cable of the corresponding specification.

The outer protection casing 200 wraps the metal wire armoring 100. The outer protection casing 200 may preferably be made of a flame-retardant, ultraviolet-resistant outdoor insulating material, which may be a material such as PVC, PE or LSZH. In terms of size, the outer diameter of the outer protection casing 200 is equal to the outer diameter of the coaxial feeder cable of the corresponding specification. Since the outer diameter of the metal wire armoring 100 is equal to the outer diameter of the coaxial feeder cable of the corresponding specification, and the outer diameter of the outer protection casing 200 is equal to the outer diameter of the coaxial feeder cable of the corresponding specification, a cable grip, a grounding clamp and a hanging net of the existing coaxial feeder cable of the same specification can be fully utilized to install the optoelectronic hybrid cable of the present invention, which is convenient for fixing and grounding. A customized cable grip and hanging net are not needed. In addition, the grounding performance is favorable and is superior to that of the existing corrugated armored hybrid cable.

Furthermore, in order to reduce the stripping difficulty of the hybrid cable, a rip cord 400 is arranged on the metal wire armoring 100 in the present invention.

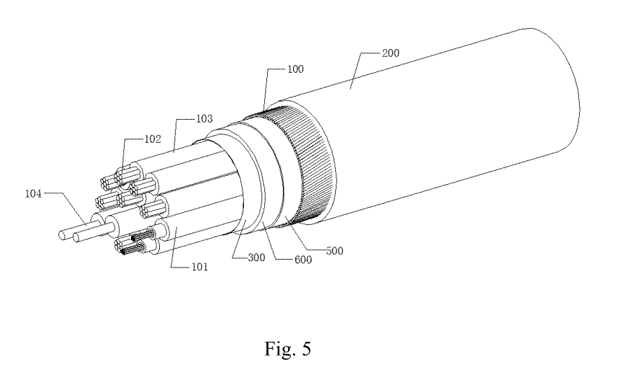

FIGS. 4 and 5 illustrate a sectional view and a perspective view of another embodiment of the optoelectronic hybrid cable of the present invention. Unlike the embodiment as shown in FIG. 3, in this embodiment, the water-blocking tape comprises a first water-blocking tape 300 and a second water-blocking tape 500, and an inner protection casing 600 additionally arranged between the first water-blocking tape 300 and the second water-blocking tape 500.

Specifically, the first water-blocking tape 3 wraps the optoelectronic hybrid unit, the inner protection casing 600 wraps the first water-blocking tape 300, the second water-blocking tape 500 wraps the inner protection casing 600 and the metal wire armoring 100 wraps the second water-blocking tape 500. The first water-blocking tape 300 and the second water-blocking tape 500 are made of materials the same as those in the above embodiments, and are also used to prevent water from entering the hybrid cable. The inner protection casing 600 is made of the same material as the outer protection casing 200, and is preferably a flame-retardant, ultraviolet-resistant outdoor insulating material, which may be PVC, PE or LSZH. The first and second water-blocking tapes and the inner protection casing 600 are arranged to further enhance the waterproof performance of the hybrid cable.

In terms of size, similarly, the outer diameter of the metal wire armoring 100 is equal to the outer diameter of the coaxial feeder cable of the corresponding specification, and the outer diameter of the outer protection casing 200 is equal to the outer diameter of the coaxial feeder cable of the corresponding specification,

In addition, unlike the embodiment shown in FIG. 3 above, in this embodiment, the inner protection casing 600 and the metal wire armoring 100 are provided with a rip cord 400 respectively for reducing the stripping difficulty of the hybrid cable.

The technical content and technical features of the present invention have been disclosed as above, and those skilled in the art can still make various substitutions and modifications based on the teaching and disclosure of the present invention, without departing from the spirit and scope of the present invention. Therefore, the protection scope of the present invention should not be limited to the content disclosed by the embodiments, but should include various substitutions and modifications without departing from the present invention and should be covered by the claims of this patent application.

1-13. (canceled)

14. A metal wire armored optoelectronic hybrid cable, comprising an optoelectronic hybrid unit, a metal wire armoring and an outer protection casing, wherein the optoelectronic hybrid unit comprises an electrical unit and an optical unit which are mixed; the metal wire armoring wraps the optoelectronic hybrid unit; the outer protection casing wraps the metal wire armoring; wherein the metal wire armoring is formed by doubled wrapping the optoelectronic hybrid unit with at least a metal line in an axial or radial direction of the optoelectronic hybrid unit.

15. The metal wire armored optoelectronic hybrid cable according to claim 14, wherein the metal wire is a single metal wire or is formed by doubling and stranding a plurality of metal wires together.

16. The metal wire armored optoelectronic hybrid cable according to claim 14, wherein the optoelectronic hybrid unit further comprises at least one reinforcement that is mixed with the optical unit and the electrical unit.

17. The metal wire armored optoelectronic hybrid cable according to claim 14, wherein the metal wire armoring further a water-blocking tape between the optoelectronic hybrid unit and the metal wire armoring.

18. The metal wire armored optoelectronic hybrid cable according to claim 17, wherein the water-blocking tape wraps the optoelectronic hybrid unit, and the metal wire armoring wraps the water-blocking tape.

19. The metal wire armored optoelectronic hybrid cable according to claim 17, wherein the water-blocking tape comprises a first water-blocking tape and a second water-blocking tape, wherein the first water-blocking tape wraps the optoelectronic hybrid unit, and the second water-blocking tape is located outside the first water-blocking tape.

20. The metal wire armored optoelectronic hybrid cable according to claim 19, wherein the metal wire armoring further comprises an inner protection casing which wraps the first water-blocking tape, and the second water-blocking tape wraps the inner protection casing.

21. The metal wire armored optoelectronic hybrid cable according to claim 17, wherein the metal wire armoring further comprises a rip cord which is arranged on the metal wire armoring, or simultaneously arranged on the metal wire armoring and the first water-blocking tape.

22. The metal wire armored optoelectronic hybrid cable according to claim 14, wherein the metal wire armoring is made of aluminum, magnesium or copper.

23. The metal wire armored optoelectronic hybrid cable according to claim 14, wherein the electrical unit comprises at least two telecommunication links, and each telecommunication link comprises a power conductor formed by stranding a plurality of metal wires and an insulating material wrapping the power conductor.

24. The metal wire armored optoelectronic hybrid cable according to claim 14, wherein the optical unit comprises one or more pairs of optical fiber cores.

25. The metal wire armored optoelectronic hybrid cable according to claim 19, wherein the inner protection casing and the outer protection casing are selected from the group consisting of PVC, PE or LSZH materials.

26. The metal wire armored optoelectronic hybrid cable according to claim 14, wherein the outer diameter of the metal wire armoring is equal to the outer diameter of a coaxial feeder cable of the corresponding specification, and the outer diameter of the outer protection casing is equal to the outer diameter of the coaxial feeder cable of the corresponding specification.
